(19) United States
(12) Patent Application Publication
(10) Pub. No.: US 2006/0042169 A1
(43) Pub. Date: Mar. 2, 2006

(54) Modular door structure

(76) Inventor: Jose Salazar, San Nicolas De Los Garza (MX)

Correspondence Address: John A. Thomas, 2200 One Galleria Tower, 13355 Noel Road, L.B. 48, Dallas, TX, 75240-1518, US

(21) Appl. No.: 11/074,126

(22) Filed: Mar. 7, 2005

(30) Foreign Application Priority Data
Sep. 2, 2004 (MX) PA/U/04/00192

(51) Int. Cl. E05D 7/00

(52) U.S. Cl. 49/400

(57) ABSTRACT

A modular door structure comprises modular components, made up of an outer frame which is mounted in the hole in the wall, a door frame affixed to the outer frame, so that it may swing open, a support frame for a translucent panel, affixed, so that it may swing open, to the door frame and a removable modular grating affixed to the door frame, all of the elements being replaceable.

### CLAIM FOR PRIORITY

This application claims the priority of Mexican Patent Application serial number PA/u/2004/000192, titled “Estructura Modular de Puerta.”

### TECHNICAL FIELD

The present invention is related to the construction of houses and buildings specifically to the modular structure of doors for houses.

### BACKGROUND

Nowadays in the industry of the construction of houses and buildings, and specifically with reference to the production, elaboration and installation of doors for these types of buildings, the doors are made and installed using traditional systems. For example, doors are usually made up of a frame on which the door is mounted with diverse configurations through a system of hinges that allow the door to swing open and shut. Other structures for doors also include an outer protective gate which many times is independent, made of another separate structure, and installed externally. Others, for example, consist of a hollow in the middle where glass is to be placed.

Most doors require the use of multiple tools for their installation, and generally require installation by a specialist in the field, that is, for metal doors a worker with welding equipment and special tools for cutting metal, all of these are obviously needed during the building of the door as well as during the installation once the door is finished. It is also very difficult to move doors of larger dimensions since they are made in a workshop or at the place where they are to be installed. This implies more manual labor and elevated costs for moving the door or for moving the machinery, equipment and personnel to the site where the door is to be made.

On the other hand, wooden doors require the work of a carpenter with his special tools for cutting wood. Many times, due to poor measuring or because of variations of the dimensions of the space where a door is to be installed, structural changes of the doors or adaptations become necessary and this implies more work, wasting time and material and more manual labor.

Most doors are products which generally must be custom made according to the needs of the consumer and for this reason the production is of low volumes, thus limiting mass production of these doors.

With technological advances, prefabricated wooden and aluminum doors, among others, are being developed and these are sold in supermarkets and home furnishing stores. However, these doors are usually plain, their structure fragile and their installation difficult.

Therefore, in the face of these inconveniences, a modular door structure which solves the aforementioned problems and also provides considerable advantages from the point of view of structure, function, cost, labor, etc. would represent great advantages in the market.

### SUMMARY

The modular door structure, according to the present disclosure, consists of the following modular components: an outside frame which is set into an opening in the wall, a door frame that can swing open and shut affixed to the outer frame, a supporting frame with a translucent panel affixed so that it may swing open in the door frame and a detachable modular grating affixed to the door frame; the entirety of the modular elements being replaceable.

The outer frame is adapted to be installed to wooden structures in houses, in concrete structures, or in metal structures, since it has of a plurality of perforations distributed along the entire section into which affixing elements may be inserted.

The modular components are attached independently in the correct order, thus facilitating installation since these independent components are lighter and easier to handle.

The modular door structure thus comprises an outer frame for mounting in an opening in a wall; a door frame hinged to the outer frame so that the door frame may swing open in the outer frame; and, a support frame hinged to the door frame so that the support frame may swing open in the door frame. The door frame and the support frame define a peripheral space when the support frame is closed upon the door frame. A modular grating can be inserted into the peripheral space and held there.

The modular door structure further comprises an upper vertical and horizontal stop affixed to the outer frame for stopping the closing of the door frame with respect to the outer frame. An outer frame element is affixed to the outer frame, and the support frame is hinged to the outer frame element. An inner frame element is connected substantially out of phase with respect to the outer frame element, and the inner frame element is affixed to the outer frame element. Thus, the inner frame element, the outer frame element, and the support frame when closed define the peripheral space. A plurality of perforations in the outer frame element are provided for affixing the removable modular grating in the peripheral space, so that the inner frame element externally covers and protects the peripheral portion of the modular grating. The support frame further comprises a peripheral channel for holding a translucent panel.

The modular door structure has a first sealing element placed on the inner face of the outer frame between the upper vertical and horizontal stop element, and the outer edge of the door frame. There is a second sealing element placed peripherally on the inner frame element, so that when the modular door is closed, the second sealing element contacts the outer frame element.

The outer frame is constructed of a pair of vertical tubes on the side of the frame toward the wall; a plurality of transversal reinforcements is connected between the vertical tubes; and, a covering plate is attached between the vertical tubes.

In embodiments where the modular door is made of metal, such as iron, machined plates are used to facilitate the installation of door knobs and door locks, so that these are flat to the door.

In order to better understand the characteristics of the invention, drawings of the preferred embodiment accompany the present description as an integral part of the same, with illustrative but not limiting ends.

### DESCRIPTION OF THE FIGURES

FIG. 1 shows a conventional perspective of a top view of a portion of the modular door structure.

FIG. 2 shows a conventional perspective of an inside view of a portion of the modular door structures shown in FIG. 1.

FIG. 3 shows a top view of a portion of the modular door structure, shown in FIGS. 1 and 2.

FIG. 4 shows an inside view of the portion of the modular door structure, shown in FIGS. 1 to 3.

FIG. 5 shows an outside view of a portion of the modular door structure, shown in FIGS. 1 to 4.

FIG. 6 shows a front view of the modular door structure, completely assembled.

FIG. 7 shows a dismantled figure in conventional perspective of one of the embodiments of the modular door structure.

In order to better understand the invention, we will now make a detailed description of some of the embodiments of the same, shown in the illustrations which are annexed to the present description with illustrative, but not limiting purposes.

### DETAILED DESCRIPTION

The details characteristic of the modular door structure are clearly showed in the following description and in the illustrative drawings which are annexed, the same numbers being used to make reference to the parts in the description and in the drawings.

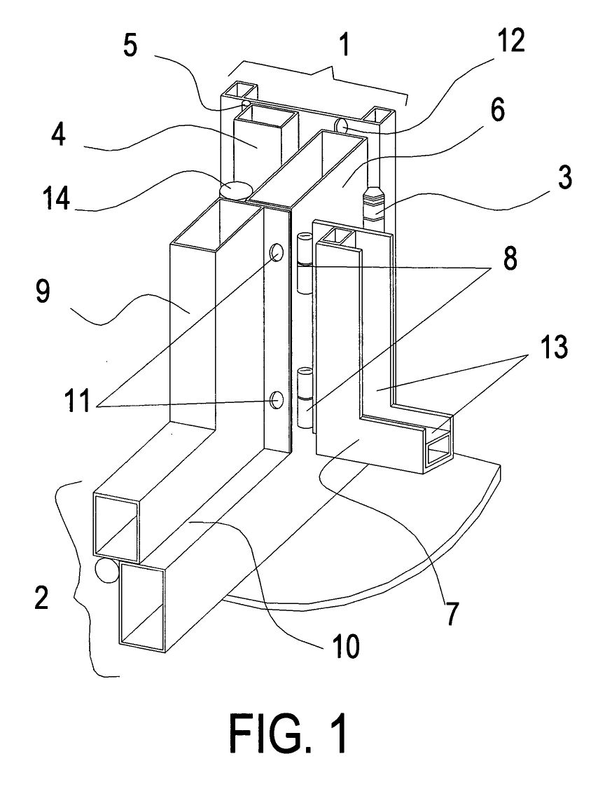

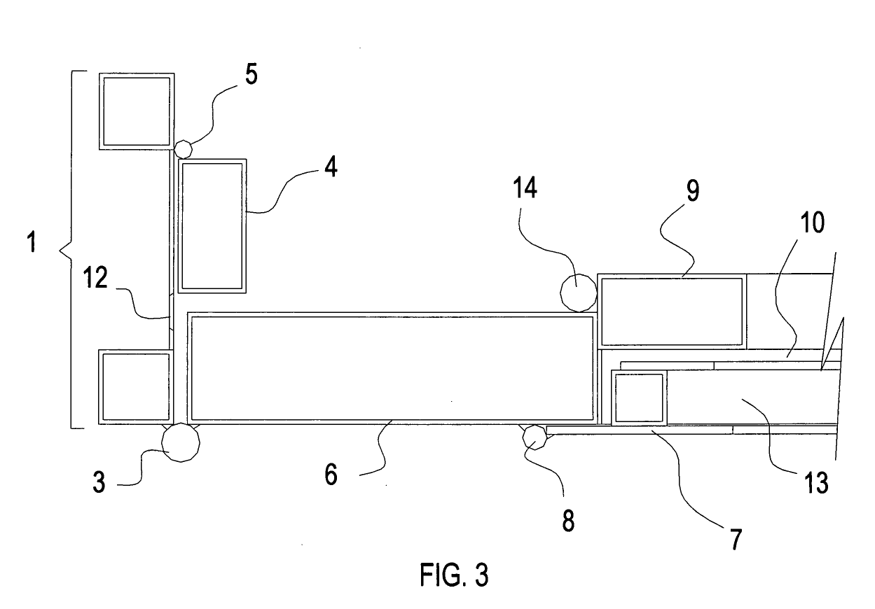

Referring to FIGS. 1 and 3, in the figures, the modular door structure of the present invention is made up of modular components which consist of an outer frame (1) which is mounted in the opening in a wall, a door frame (2) affixed so that it may swing open to the outer frame (1) through a system of hinges (3) placed between the inner edge of the outer frame (1) and the outer edge of the door frame (2). The outer frame (1) consists of an upper stop element (4), placed vertically and horizontally along the entire section as a means to stop the closing of the door frame (2) with respect to the outer frame (1). A first sealing element (5) is placed on the inner face of the outer frame (1) between the upper vertical and horizontal stop element (4), and the outer edge of the door frame (2). Such sealing elements are typically substantially “V” shaped.

The door frame (2) comprises an outer frame element (6) that is attached to the outer frame (1) and to which also is affixed a support frame (7) for a translucent panel (not shown) on the inner face so that it may swing open, the panel may be glass, plastic or other similar material. The support frame (7) is affixed with a system of hinges (8) near the inner edge, and a inner frame element (9) of the door frame (2) lies substantially out of phase with respect to the outer frame element (6) and affixed to the edge of the latter with an extension, creating a peripheral space (10) between the two where a modular grating (19) is placed, affixed so that it can be detached with affixing means (not shown) which are inserted into a plurality of perforations (11) made in the inner edge of the outer frame element (6) of the door frame and the inner frame element (9) of the door frame (2). The inner frame (9) externally covers and protecting the peripheral portion of the modular grating (19), thus preventing external access to the affixing means of the modular grating (19).

The outer frame consists of a plurality of perforations (12), distributed along the entire section into which may be inserted affixing elements for affixing it to the edges of the opening in the wall.

The supporting frame (7) with the translucent panel has a peripheral channel (13) in which the translucent panel is placed (not shown), and it swings towards the modular grating (19).

A second sealing element (14) is placed peripherally on the outer face of a flange of the supporting frame (7) for the translucent panel which upon closing comes into contact with part of the inner face of the outer frame element (6) of the door frame (2), forming a peripheral seal.

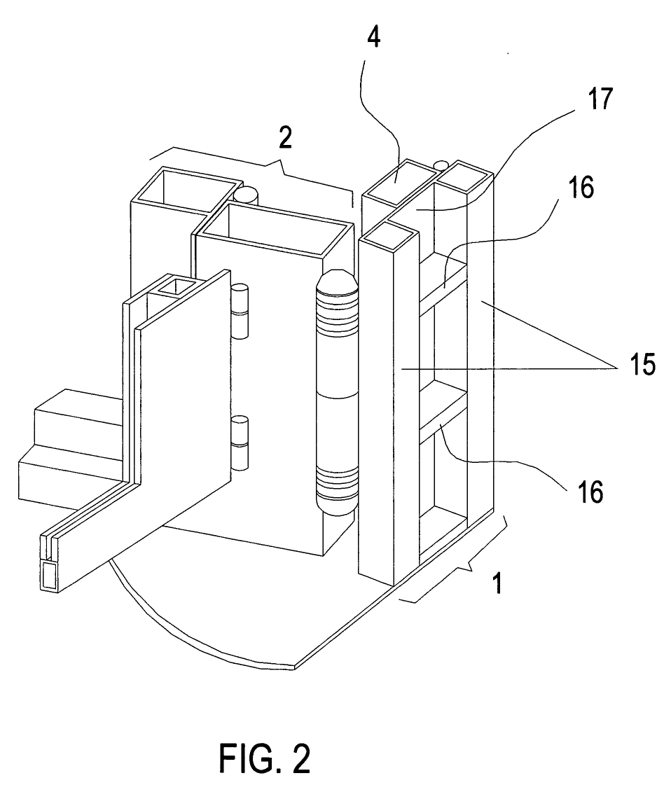

FIG. 2 illustrates a conventional view of the inner portion of the modular door structure shown in FIG. 1. FIG. 2 shows the outer frame (1) comprising of a pair of vertical tubular bodies on the outer side (15) attached transversally along the entire section through a plurality of transversal reinforcements (16) and on whose outer face the covering plate (17) is affixed, on the plate the stop element (4) of the door frame (2) is attached.

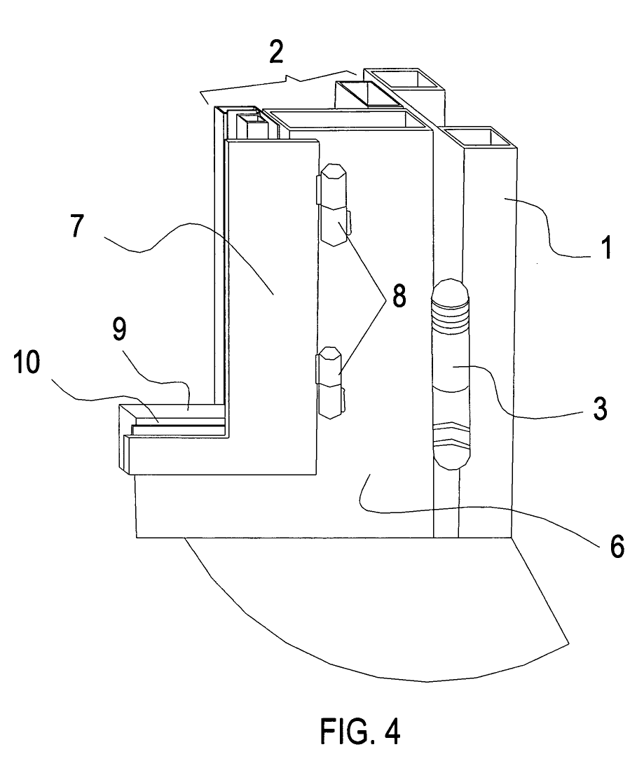

FIG. 4 shows a top view of a portion of the modular door structure. In FIG. 4, the outer frame element (6) of the door frame (2) is affixed, so that it may swing open, through a system of hinges (3) to the outer frame (1). Hinges (8) are placed on the inner part of the door as the hinges (8) of the support frame (7) of the translucent paned (not shown). The support frame (7) for the translucent panel in the closed position leaves a peripheral space (10) with respect to the inner frame element (9) of the door frame (2).

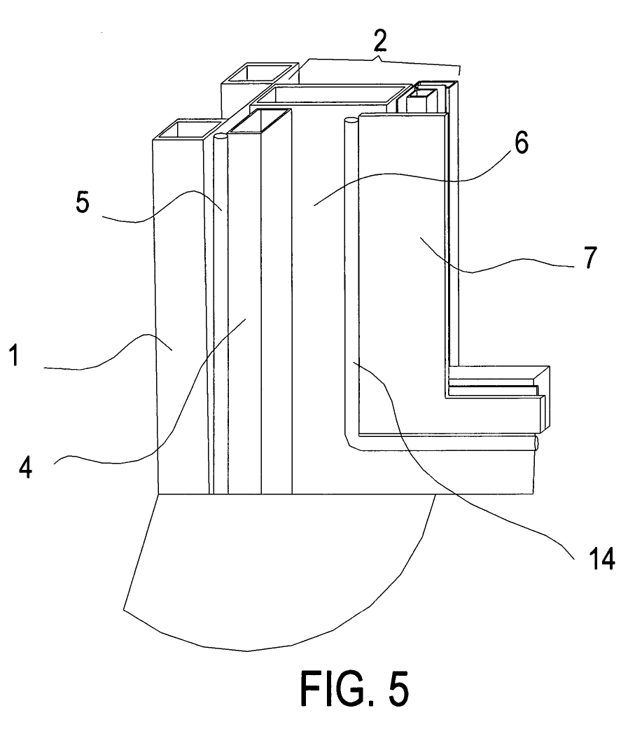

FIG. 5 shows an inside view of the portion of the modular door structure. In the figure, the air tightness between the modular components may be observed. This prevents air and water from coming in, since on the one hand, the first seal element (5), affixed to the outer frame between the vertical stop (4) and the door frame (2) together seal and block the coupling between the outer frame element (6) of the door frame (2) and the outer frame (1); and on the other hand, the second element (14) seals the space made between the outer frame element (6) of door frame (2) and the support frame (7) of the translucent panel. In the preferred embodiment, the latter sealing element consists of a flat neoprene tape with adhesive on the face for adherence to the corresponding surface of the translucent panel.

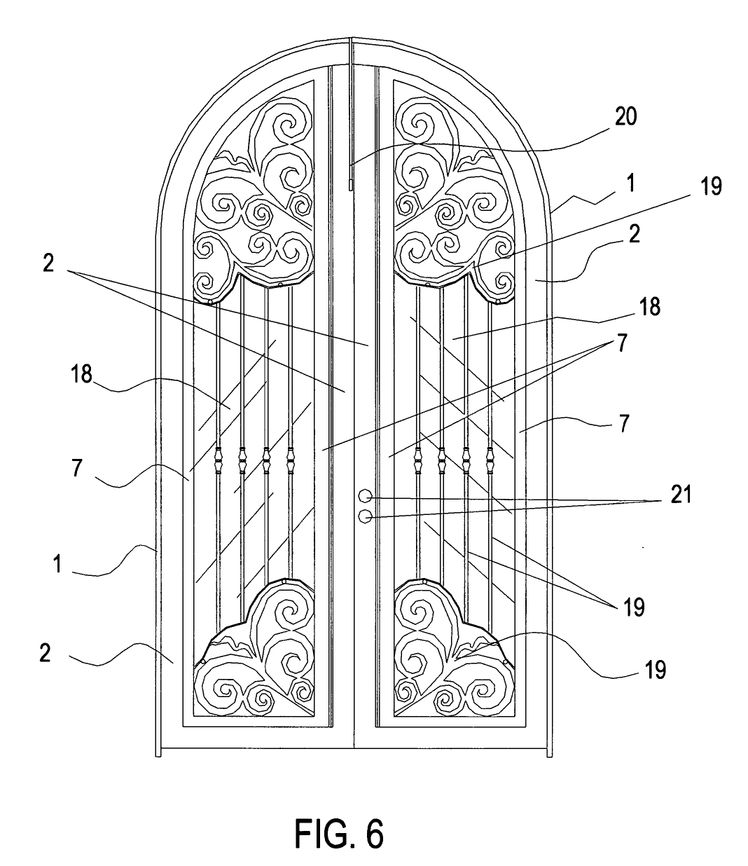

FIG. 6 shows a front view of the modular door structure. In FIG. 6 the modular door structure, composed as has been described in the previous figures, in which the outer frame (1) receives the door frame (2), affixed through a system of hinges, and the door frame receives the support frame (7) for the translucent panel (18) behind the modular grating (19). The modular grating (19) is mounted in the peripheral space (10) between the inner frame element (9) and the outer frame element (6) of the door frame (2) (see FIGS. 1 to 4), leaving the translucent pane (18) placed in the inner part behind the modular grating (19), supported in the support frame (7), affixed, so that it may swing open, in the outer frame element (6) of the door frame through a system of hinges (again see FIGS. 1 to 4).

The door is preferably made in two leaves and with an upper central arch, thus only consisting of one outer frame (1) and the other elements divided in half in order to form the two folding leaves where each leaf makes up one door frame (2), a modular grating (19) and a support frame (7) for the translucent panel (18), like ordinary doors, having an upper bolt (20) in one of the leaves and at least one lock (21), handles and door pulls.

The door may be made up of two rectangular leaves, a single rectangular leaf or a single leaf with an upper arched panel, etc. In any configuration, the elements described and shown throughout the description and in the drawings respectively, the method applies.

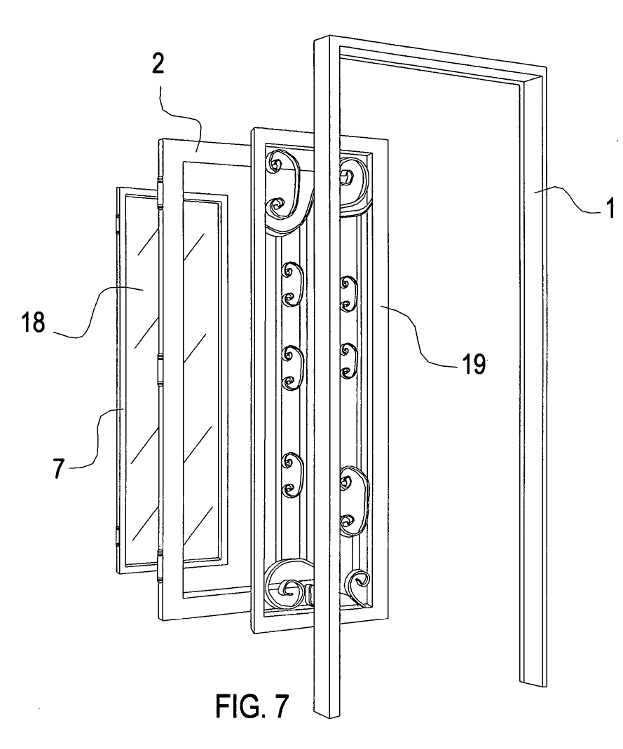

FIG. 7 shows a broken down conventional perspective of one of the embodiments of the modular door structure. In the figure the outer frame (1) may be observed, independently of the other modular elements. In the outer frame (1) the swinging door frame (2) is mounted, and this is affixed to the modular grating (19), in the door frame (2) the support frame (7) for the translucent panel is affixed so that it too swings.

The preferred embodiments have been sufficiently described so that any person with knowledge of the art may reproduce and obtain the results mentioned in the present disclosure. However, any person skilled in the art of the technique of the present disclosure will be able to make modifications not described in the present application and if for the application of these modifications the material claimed herein is needed, them the structures fall within the scope of the present invention.

I claim:

1. A modular door structure, comprising:
an outer frame for mounting in an opening in a wall;
a door frame hinged to the outer frame so that the door frame may swing open in the outer frame;
a support frame hinged to the door frame so that the support frame may swing open in the door frame;
the door frame and the support frame defining a peripheral space when the support frame is closed upon the door frame; and,
a modular grating removably held in the peripheral space.

2. The modular door structure, as described in claim 1, further comprising an upper vertical and horizontal stop affixed to the outer frame for stopping the closing of the door frame with respect to the outer frame.

3. The modular door structure, as described in claim 1, where the door frame further comprises:
a outer frame element; the outer frame element affixed to the outer frame;
the support frame hinged to the outer frame element;
an inner frame element substantially out of phase with respect to the outer frame element; the inner frame element affixed to the outer frame element; the inner frame element, the outer frame element, and the support frame when closed defining the peripheral space;
a plurality of perforations in the outer frame element for affixing the removable modular grating in the peripheral space, so that the inner frame element externally covers and protects the peripheral portion of the modular grating.

4. The modular door structure, as described in claim 1, where the support frame further comprises a peripheral channel for holding a translucent panel.

5. The modular door structure, as described in claim 1, where the outer frame further comprises a plurality of perforations, for inserting affixing elements to connect the outer frame to the wall.

6. The modular door structure, as described in claim 2, further comprising a first sealing element placed on the inner face of the outer frame between the upper vertical and horizontal stop element, and the outer edge of the door frame.

7. The modular door structure, as described in claim 2, comprising a second sealing element placed peripherally on the inner frame element, so that when the modular door is closed, the second sealing element contacts the outer frame element.

8. The modular door structure, as described in claim 1, where the outer frame further comprises: a pair of vertical tubes on the side of the frame toward the wall; a plurality of transversal reinforcements connected between the vertical tubes; and, a covering plate attached between the vertical tubes.
